(19) United States
(12) Patent Application Publication
(10) Pub. No.: US 2013/0337324 A1
(43) Pub. Date: Dec. 19, 2013

(54) NONAQUEOUS ELECTROLYTE SECONDARY BATTERY AND METHOD FOR MANUFACTURING SAME

(71) Applicants: Mai Yokoi, Tokushima (JP); Tadayoshi Tanaka, Osaka (JP); Hiroshi Minami, Hyogo (JP); Naoki Imachi, Hyogo (JP)

(72) Inventors: Mai Yokoi, Tokushima (JP); Tadayoshi Tanaka, Osaka (JP); Hiroshi Minami, Hyogo (JP); Naoki Imachi, Hyogo (JP)

(73) Assignee: SANYO ELECTRIC CO., LTD., Moriguchi-shi, Osaka (JP)

(21) Appl. No.: 14/002,515

(22) PCT Filed: Mar. 5, 2012
(86) PCT No.: PCT/JP2012/055568

§ 371 Date: Aug. 30, 2013

(30) Foreign Application Priority Data
Mar. 16, 2011 (JP) 2011-057541

(51) Int. Cl. H01M 4/134; H01M 4/583

(52) U.S. Cl. CPC H01M 4/134; H01M 4/583
USPC 429/217

(57) ABSTRACT

Provided is a nonaqueous electrolyte secondary battery in which a mixture of a graphite material and silicon or a silicon compound is used as a negative electrode active material and which has excellent cycle characteristics. A nonaqueous electrolyte secondary battery includes a positive electrode containing a positive electrode active material, a negative electrode containing a negative electrode active material, and a nonaqueous electrolyte, and is wherein the negative electrode contains the negative electrode active material and a negative electrode binder, the negative electrode active material is a mixture of a graphite material and silicon and/or a silicon compound that is contained in an amount less than that of the graphite material, and the negative electrode binder is polyacrylonitrile or a modified form thereof which has been heat-treated.

### TECHNICAL FIELD

The present invention relates to a nonaqueous electrolyte secondary battery, such as a lithium-ion secondary battery, and a method for manufacturing the same.

### BACKGROUND ART

In recent years, nonaqueous electrolyte secondary batteries, which are configured to perform charging and discharging by using a nonaqueous electrolyte solution and moving lithium ions between a positive electrode and a negative electrode, have been used as power sources for mobile electronic devices, electricity storage, and the like. In such nonaqueous electrolyte secondary batteries, a graphite material has been widely used as a negative electrode active material in the negative electrode thereof.

In the case of a graphite material, the discharge potential is flat, and intercalation/desorption of lithium ions takes place between graphite crystal layers in the charge/discharge process. Therefore, the graphite material inhibits formation of acicular metal lithium and undergoes a small change in volume due to charging and discharging, all of which are advantageous.

Furthermore, in recent years, in order to cope with increases in functionality and performance of mobile electronic devices and the like, there has been a demand for nonaqueous electrolyte secondary batteries having higher capacities. In the case of the graphite material, the theoretical capacity of LiC₆, which is an intercalation compound, is low at 372 mAh/g and the above-mentioned demand cannot be met satisfactorily, which is a problem.

For this reason, in recent years, use of silicon, tin, aluminum, or the like that forms an alloy with lithium ions, as a negative electrode active material having a high capacity, has been under study. In particular, in the case of silicon, since the theoretical capacity per unit weight is very high at about 4,200 mAh/g, various studies have been conducted on the practical application of silicon.

However, silicon or the like that forms an alloy with lithium ions undergoes a large change in volume caused by occlusion/release of lithium ions, and the expansion/contraction of the negative electrode active material increases. As a result, the capacity is intermittently decreased by reactions between the electrolyte solution and surfaces newly formed by detachment between negative electrode active material particles or between the negative electrode active material and a current collector, and the cycle characteristics of the nonaqueous electrolyte secondary battery are degraded, which is a problem.

For this reason, as shown in Patent Literatures 1 to 3, it is proposed that, using a composite carbonaceous material which is obtained by making silicon, aluminum, or the like that forms an alloy with lithium ions to be carried on the surface of carbon particles and by further coating the surface of the carbon particles with a carbon material, a change in volume of silicon, aluminum, or the like caused by occlusion/release of lithium ions is absorbed so that the cycle characteristics of the nonaqueous electrolyte secondary battery can be improved.

Furthermore, Patent Literature 4 proposes a lithium secondary battery which uses a negative electrode obtained by sintering, at a temperature of 200° C. to 500° C., a negative electrode mixture layer containing negative electrode active material particles containing silicon and a negative electrode binder, such as a polyimide resin, polyvinylidene fluoride, or polytetrafluoroethylene, on the surface of a negative electrode current collector.

### CITATION LIST

### Patent Literature

PTL 1: Japanese Published Unexamined Patent Application No. 5-286763
PTL 2: Japanese Published Unexamined Patent Application No. 2007-87956
PTL 3: Japanese Published Unexamined Patent Application No. 2008-27897
PTL 4: Japanese Published Unexamined Patent Application No. 2007-213875

### SUMMARY OF INVENTION

### Technical Problem

However, even in the nonaqueous electrolyte secondary battery proposed in any of Patent Literatures 1 to 3, the cycle characteristics cannot be improved sufficiently, which is a problem.

Furthermore, when polyimide is used as a binder as described in Patent Literature 4, in the case where a mixture of graphite and silicon or a silicon compound is used as a negative electrode active material, the slurry properties of the negative electrode mixture slurry are degraded, and application cannot be performed, which is a problem. Consequently, in the case where a mixture of graphite and silicon or a silicon compound is used as a negative electrode active material, it is not possible to use polyimide as a binder, which is a problem.

It is an object of the present invention to provide a nonaqueous electrolyte secondary battery in which a mixture of a graphite material and silicon or a silicon compound is used as a negative electrode active material and which has excellent cycle characteristics.

### Solution to Problem

A nonaqueous electrolyte secondary battery according to the present invention includes a positive electrode containing a positive electrode active material, a negative electrode containing a negative electrode active material, and a nonaqueous electrolyte, and is wherein the negative electrode contains the negative electrode active material and a negative electrode binder, the negative electrode active material is a mixture of a graphite material and silicon and/or a silicon compound that is contained in an amount less than that of the graphite material, and the negative electrode binder is polyacrylonitrile or a modified form thereof which has been heat-treated.

According to the present invention, it is possible to obtain a nonaqueous electrolyte secondary battery having excellent cycle characteristics.

In the present invention, the content of the negative electrode binder in the negative electrode is preferably in a range of 2.0 to 10.0 parts by mass relative to 100 parts by mass of the negative electrode active material. When the content of the negative electrode binder is excessively low, adhesion of the negative electrode active material layer to the negative electrode current collector is decreased, and there is a concern that the negative electrode active material layer may fall off from the negative electrode current collector. On the other hand, when the content of the negative electrode binder is excessively high, charge/discharge reactions are hindered by the binder, and it may not be possible to obtain a designed capacity in some cases. The content of the negative electrode binder is more preferably in a range of 2.0 to 5.0 parts by mass.

In the present invention, the content of silicon and the silicon compound in the negative electrode is preferably less than 20% by mass, and more preferably in a range of 2.0% to 12.0% by mass, relative to the total negative electrode active material. When the content of silicon and the silicon compound is excessively low, it becomes difficult to obtain the effect of increasing the capacity of the battery, which is the effect expected by using silicon and/or the silicon compound as the negative electrode active material. On the other hand, when the content of silicon and the silicon compound is excessively high, it is believed that the influence of the change in volume of silicon increases.

A manufacturing method of the present invention is a method which can manufacture the nonaqueous electrolyte secondary battery of the present invention described above. The method is characterized by including a step of preparing a negative electrode mixture slurry which contains a mixture of a graphite material and silicon and/or a silicon compound as a negative electrode active material, and polyacrylonitrile or a modified form thereof as a negative electrode binder; a step of producing a negative electrode precursor by applying the negative electrode mixture slurry onto a negative electrode current collector; a step of producing a negative electrode by heat-treating the negative electrode precursor so as to heat-treat the polyacrylonitrile or a modified form thereof; and a step of producing a nonaqueous electrolyte secondary battery including the negative electrode, a positive electrode, and a nonaqueous electrolyte.

According to the manufacturing method of the present invention, a nonaqueous electrolyte secondary battery having excellent cycle characteristics can be manufactured efficiently.

In the manufacturing method of the present invention, by heat-treating the negative electrode precursor, polyacrylonitrile or a modified form thereof, which is the negative electrode binder, is heat-treated. The heat treatment is performed in an inert atmosphere. Examples of the inert atmosphere include a vacuum atmosphere and an inert gas atmosphere. Examples of the inert gas atmosphere include an atmosphere of an inert gas, such as argon, and an atmosphere of a gas, such as nitrogen. The heat treatment temperature is preferably higher than the glass transition temperature of the negative electrode binder by 10° C. or more and lower than the melting point of the negative electrode binder. Furthermore, the heat treatment temperature is preferably in a range of 130° C. to 200° C. When the heat treatment temperature is lower than 130° C., the effect due to heat treatment may not be obtained sufficiently in some cases. When the heat treatment temperature exceeds 200° C., it may become difficult to obtain the strength of the current collector, such as a copper foil, in some cases. The heat treatment temperature is more preferably in a range of 150° C. to 190° C.

In the present invention, the negative electrode active material is, as described above, a mixture of a graphite material and silicon and/or a silicon compound. Examples of the mixture include a composite in which silicon and/or a silicon compound is carried on the surface of a graphite material, and a composite in which a graphite material is carried on the surface of silicon or a silicon compound. Examples of the graphite material include artificial graphite and natural graphite. Examples of silicon include polycrystalline silicon and amorphous silicon. Examples of the silicon compound include SiO and SiO₂.

In the present invention, the average particle size of silicon or the silicon compound is preferably in a range of 1 to 6 μm. When the average particle size is less than 1 μm, the specific surface area of the negative electrode active material increases, and the negative electrode active material may easily react with the electrolyte solution in some cases. On the other hand, when the average particle size exceeds 6 μm, silicon or the silicon compound precipitates heavily in the slurry, and application may become difficult in some cases.

The positive electrode active material is not particularly limited as long as it can occlude and release lithium and its potential is noble. For example, lithium transition metal composite oxides having a layered structure, a spinel structure, or an olivine structure can be used. Among them, from the standpoint of high energy density, a lithium transition metal composite oxide having a layered structure is preferable. Examples of such a lithium transition metal composite oxide include a lithium-nickel composite oxide, a lithium-nickel-cobalt composite oxide, a lithium-nickel-cobalt-aluminum composite oxide, a lithium-nickel-cobalt-manganese composite oxide, and a lithium-cobalt composite oxide.

Examples of the binder used for the positive electrode include fluororesins having a vinylidene fluoride unit, such as polyvinylidene fluoride (PVDF) and modified forms of PVDF.

As the solvent of the nonaqueous electrolyte, for example, any solvent commonly used for nonaqueous electrolyte secondary batteries can be used. Above all, a mixed solvent of a cyclic carbonate and a linear carbonate is particularly preferably used. Specifically, the mixing ratio between a cyclic carbonate and a linear carbonate (cyclic carbonate:linear carbonate) is preferably set in a range of 1:9 to 5:5.

Examples of the cyclic carbonate include ethylene carbonate, fluoroethylene carbonate, propylene carbonate, butylene carbonate, vinylene carbonate, and vinyl ethylene carbonate. Examples of the linear carbonate include dimethyl carbonate, methyl ethyl carbonate, and diethyl carbonate.

Examples of the solute of the nonaqueous electrolyte include LiPF₆, LiBF₄, LiCF₃SO₃, LiN(SO₂F)₂, LiN(SO₂CF₃)₂, LiN(SO₂C₂F₅)₂, LiC(SO₂CF₃)₃, LiC(SO₂C₂F₅)₃, LiClO₄, and mixtures of these.

Furthermore, as the electrolyte, a gel polymer electrolyte, which is formed by impregnating a polymer, such as polyethylene oxide or polyacrylonitrile, with an electrolyte solution, may be used.

### Advantageous Effects of Invention

According to the present invention, in a nonaqueous electrolyte secondary battery in which a mixture of a graphite material and silicon and/or a silicon compound is used, excellent charge/discharge cycle characteristics can be obtained.

### BRIEF DESCRIPTION OF DRAWINGS

FIG. 1 is a schematic view showing a three-electrode test cell used in Examples.

FIG. 2 is a schematic view showing an electrode body in the three-electrode test cell used in Examples.

### DESCRIPTION OF EMBODIMENTS

### Experiment 1

### Example 1

[Production of Silicon Active Material]

First, a polycrystalline silicon mass was produced by a thermal reduction process. Specifically, a silicon core placed in a metal reactor (reduction furnace) was heated by electric current to about 800° C., and a mixed gas of a vapor of high-purity monosilane (SiH₄) gas and refined hydrogen was charged into the reactor to deposit polycrystalline silicon on the surface of the silicon core. Thereby, a polycrystalline silicon mass in the form of a thick rod was produced.

Next, the polycrystalline silicon mass was pulverized and classified into polycrystalline particles (silicon active material) with a purity of 99%. The resulting polycrystalline particles had a crystallite size of 32 nm and a median diameter of 10 μm. The crystallite size was calculated from the scherrer equation using the half peak width of silicon (111) measured by powder X-ray diffraction. The median diameter was defined as a diameter at a cumulative volume of 50% in a particle size distribution measurement by laser diffractometry.

[Production of Negative Electrode]

A negative electrode mixture slurry was prepared by adding graphite serving as a carbon material, the silicon particles described above, and polyacrylonitrile serving as a negative electrode binder into N-methyl-2-pyrrolidone (NMP) serving as a dispersion medium such that the mass ratio of carbon material (graphite):silicon:polyacrylonitrile was 92:8:3, followed by mixing.

The negative electrode mixture slurry was applied onto the surface of a copper foil serving as a current collector. Drying was performed in the air at 105° C., followed by rolling. Thereby, a negative electrode precursor was obtained. The negative electrode precursor was subjected to heat treatment in a vacuum atmosphere at 150° C. for 10 hours to produce a negative electrode. The packing density of the negative electrode mixture layer was 1.70 g/cm³.

### Example 2

A negative electrode was produced as in Example 1 except that mixing was performed such that the mass ratio of carbon material (graphite):silicon:polyacrylonitrile was 92:8:2.

### Example 3

A negative electrode was produced as in Example 1 except that mixing was performed such that the mass ratio of carbon material (graphite):silicon:polyacrylonitrile was 92:8:5.

### Example 4

A negative electrode was produced as in Example 1 except that mixing was performed such that the mass ratio of carbon material (graphite):silicon:polyacrylonitrile was 92:8:10.

### Example 5

A negative electrode was produced as in Example 1 except that mixing was performed such that the mass ratio of carbon material (graphite):silicon:polyacrylonitrile was 92:8:1.

[Production of Three-Electrode Test Cell]

Three-electrode test cells were fabricated using the negative electrodes of Examples 1 to 5.

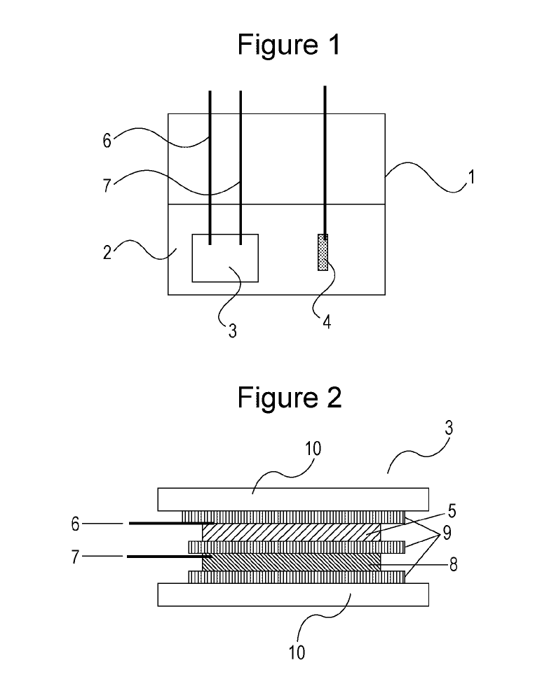

FIG. 1 is a schematic view showing one of the three-electrode test cells. An electrolyte solution 2 is placed in a container 1, and an electrode body 3 and a reference electrode 4 are arranged so as to be in contact with the electrolyte solution 2. FIG. 2 is a schematic view showing the electrode body 3.

A negative electrode 5 and a nickel tab 6 with a thickness of 0.05 mm and a width of 4 mm were stacked, punched with a pin, and press-bonded. Thereby, the nickel tab 6 was attached to the negative electrode 5. A lithium metal plate with dimensions of 25 mm×25 mm×0.4 mm to which a tab 7 was attached was used as the reference electrode 8. The tabbed negative electrode 5 and the tabbed reference electrode 8 were stacked with a porous membrane made of polypropylene 9 therebetween. The stacked body was sandwiched between two glass plates 10 and fastened with clips. Thereby, the electrode body 3 was fabricated.

As the reference electrode 4, a lithium metal plate was used.

The reference electrode 4 and the electrode body 3 were placed in the container (glass cell) 1. The electrolyte solution 2 was poured into the container 1 and then sealing was performed. Thereby, a three-electrode test cell was produced. The tabs of the electrodes and the reference electrode were fixed to clips which were connected to the outside. The electrolyte solution used was obtained by dissolving lithium hexafluorophosphate, with a concentration of 1 mol/liter, into a mixed solvent in which ethylene carbonate and diethyl carbonate were mixed at a ratio of 3:7.

[Measurement of Discharge Capacity]

Using the three-electrode test cell produced as described above, a charge-discharge test was carried out under the following charge conditions and discharge conditions to measure a discharge capacity. The capacity of the initial cycle was measured as the discharge capacity.

Charge Conditions

Constant-current charging was performed to 0.0 V at a current of 0.1 It (1.5 mA).

Discharge Conditions

Constant-current discharging was performed to 1.0 V at a current of 0.1 It (1.5 mA).

Rest

The rest period between charging and discharging was 10 minutes.

[Evaluation of Adhesion]

Adhesion was evaluated for the electrodes obtained in Examples 1 to 5. Specifically, the negative electrode subjected to charging and discharging in the three-electrode cell was taken out and wound around a round bar tool with a diameter of 5 mm. The presence or absence of cracks and detachment on the surface of the active material was confirmed. Evaluation was made on the basis of the following criteria:

◯: No cracks or detachment was observed.

Δ: Cracks and detachment were confirmed in some portions.

Table 1 shows the adhesion and discharge capacity.

TABLE 1

| | Example 5 | Example 2 | Example 1 | Example 3 | Example 4 |
|---|---|---|---|---|---|
| Binder | 1 | 2 | 3 | 5 | 10 |
| content | | | | | |
| Adhesion | Δ | ◯ | ◯ | ◯ | ◯ |
| Discharge | 13 | 15 | 15 | 14 | 11 |
| capacity | | | | | |
| (mAh) | | | | | |

As is evident from the results shown in Table 1, when the negative electrode binder content is less than 2 parts by mass relative to 100 parts by mass of the negative electrode active material, adhesion decreases. It is recognized that when the negative electrode binder content increases, the discharge capacity tends to decrease. The reason for this is believed to be that charge/discharge reactions are hindered by the binder. Consequently, it is confirmed that the negative electrode binder content in the negative electrode is preferably in a range of 2.0 to 10.0 parts by mass, and more preferably in a range of 2.0 to 5.0 parts by mass, relative to 100 parts by mass of the negative electrode active material.

### Experiment 2

### Example 6

Using the negative electrode produced in Example 1, a nonaqueous electrolyte secondary battery for testing was produced in the manner described below.

[Production of Positive Electrode]

A positive electrode mixture slurry was prepared by adding lithium cobaltate serving as a positive electrode active material, acetylene black serving as a carbon conducting agent, and polyvinylidene fluoride (PVDF) serving as a binder into NMP such that the mass ratio of lithium cobaltate:acetylene black:PVDF was 95:2.5:2.5, followed by mixing.

The resulting positive electrode mixture slurry was applied onto both surfaces of an aluminum foil, followed by drying, and then rolling was performed to produce a positive electrode. The packing density of the positive electrode active material in the positive electrode was set at 3.6 g/cm³.

[Preparation of Nonaqueous Electrolyte Solution]

An electrolyte solution was prepared by adding lithium hexafluorophosphate (LiPF₆), with a concentration of 2.0 mol/liter, in a mixed solvent in which ethylene carbonate (EC) and diethyl carbonate (DEC) were mixed at a volume ratio of 3:7.

[Assembly of Battery]

Using the positive electrode, the negative electrode, and a polyethylene separator, the positive electrode and the negative electrode were opposed to each other with the separator therebetween. Next, a positive electrode tab and a negative electrode tab were each arranged so as to be located at the outermost peripheral portion of the electrode, and winding was performed spirally. Then, the winding core was drawn out to produce a spirally wound electrode body. Then, the spirally wound electrode body was compressed to obtain a flat-type electrode body.

The resulting electrode body was placed in a battery case made of an aluminum laminate, and vacuum drying was performed at 105° C. for two hours. Then, the nonaqueous electrolyte solution was poured thereinto, and the battery case was sealed to produce a nonaqueous electrolyte secondary battery for testing. Note that the design capacity of the battery was 800 mAh.

### Example 7

A negative electrode was produced as in Example 1 except that the heat treatment conditions were set at 190° C. for 10 hours, and using the negative electrode, a battery for testing was produced as in Example 6.

### Example 8

A battery for testing was produced as in Example 7 except that silicon particles with a particle size of 1.1 μm were used as the negative electrode active material.

### Comparative Example 1

A battery for testing was produced as in Example 6 except that water was used as the dispersion medium in the preparation of a negative electrode mixture slurry, a negative electrode precursor was produced by using a carboxymethyl cellulose salt (CMC) and styrene butadiene rubber emulsion (SBR) as binders and mixing was performed such that the mass ratio of carbon material (graphite):silicon:CMC:SBR was 92:8:1:1, and the negative electrode precursor was directly used as a negative electrode without being heat-treated.

### Comparative Example 2

A battery for testing was produced as in Comparative Example 1 except that the negative electrode precursor was heat-treated at 190° C. for 10 hours, and the heat-treated precursor was used as a negative electrode.

### Comparative Example 3

A battery for testing was produced as in Example 6 except that the negative electrode precursor was directly used as a negative electrode without being heat-treated.

### Comparative Example 4

A battery for testing was produced as in Example 8 except that the negative electrode precursor was directly used as a negative electrode without being heat-treated.

### Comparative Example 5

A battery for testing was produced as in Example 6 except that a negative electrode precursor was produced using polyvinylidene fluoride, instead of polyacrylonitrile, as the negative electrode binder, and the negative electrode precursor was directly used as a negative electrode without being heat-treated.

### Comparative Example 6

A battery for testing was produced as in Comparative Example 5 except that the negative electrode precursor was heat-treated at 130° C. for 10 hours to produce a negative electrode.

[Evaluation of Battery Performance]

Using batteries for testing of Examples 6 to 8 and Comparative Examples 1 to 6, a charge-discharge test was carried out under the following charge and discharge conditions, and the capacity retention ratio at the 100th cycle was measured. The capacity retention ratio at the 100th cycle was calculated as follows:

Capacity retention ratio at the 100th cycle (%)=(Discharge capacity at the 100th cycle/Discharge capacity at the first cycle)×100

Charge Conditions

Constant-current charging was performed at a current of 1 It (800 mA) to 4.2 V, and charging was performed at a constant voltage of 4.2 V until the current reached 1/20 It (40 mA).

Discharge Conditions

Constant-current discharging was performed at a current of 1 It (800 mA) to 2.75 V.

Rest

The rest period between charging and discharging was 10 minutes.

The measurement results are shown in Table 2.

TABLE 2

| | | | Heat | Capacity |
|---|---|---|---|---|
| | | Silicon particle | treatment | retention ratio |
| | Binder | size (μm) | temperature | at 100th cycle |
| Example 6 | PAN | 5.5 | 150° C. | 81% |
| Example 7 | PAN | 5.5 | 190° C. | 86% |
| Example 8 | PAN | 1.1 | 190° C. | 82% |
| Comparative | CMC/SBR | 5.5 | No heat | 76% |
| Example 1 | | | treatment | |
| Comparative | CMC/SBR | 5.5 | 190° C. | 76% |
| Example 2 | | | | |
| Comparative | PAN | 5.5 | No heat | 77% |
| Example 3 | | | treatment | |
| Comparative | PAN | 1.1 | No heat | 76% |
| Example 4 | | | treatment | |
| Comparative | PVDF | 5.5 | No heat | 65.6% |
| Example 5 | | | treatment | |
| Comparative | PVDF | 5.5 | 130° C. | 67.6% |
| Example 6 | | | | |

As is evident from the results shown in Table 2, in Examples 6 to 8 in which polyacrylonitrile is used as the negative electrode binder and polyacrylonitrile is heat-treated in accordance with the present invention, high charge/discharge cycle characteristics are obtained compared with Comparative Examples 3 and 4 in which heat treatment is not performed.

Furthermore, as is evident from Comparative Examples 1 and 2, in the case where CMC and SBR are used as binders, the charge/discharge cycle characteristics are hardly improved even by the heat treatment of the negative electrode binders.

Furthermore, as is evident from Comparative Examples 5 and 6, in the case where PVDF is used as the negative electrode binder, although the charge/discharge cycle characteristics are slightly improved by heat treatment, the effect thereof is not so large as that in the case of polyacrylonitrile.

Consequently, it is confirmed that the effect of heat treatment in the present invention is obtained when polyacrylonitrile or a modified form thereof is used as a negative electrode binder.

Although the particular reason for improvement in charge/discharge cycle characteristics due to heat treatment is not clear, it is believed that by heat-treating polyacrylonitrile or a modified form thereof, the liquid-absorbing property of the nonaqueous electrolyte solution can be decreased, and side reactions between the nonaqueous electrolyte solution and the negative electrode active material can be inhibited.

### Reference Experiment

### Reference Example 1

Using the NMP solution of polyacrylonitrile used as the negative electrode binder in the examples described above, polyacrylonitrile was formed into a sheet. The sheet was dried in room temperature and then cut out to a size of 2 cm×5 cm. The cut out sheet was dried in a vacuum atmosphere at 105° C. for two hours, and then the weight was measured.

Subsequently, the sheet was immersed in the electrolyte solution at 60° C. for two days. After the immersion, the sheet was taken out from the electrolyte solution, and the weight was measured. The liquid content was measured in accordance with the following equation, and the measurement results are shown in Table 1.

Liquid content (%)=(Weight after immersion−Weight after drying)/Weight after immersion

### Reference Example 2

The liquid content was measured as in Reference Example 1 except that, instead of drying at 105° C. for two hours, heat treatment was performed at 150° C. for 10 hours in a vacuum atmosphere.

### Reference Example 3

The liquid content was measured as in Reference Example 1 except that, instead of drying at 105° C. for two hours, heat treatment was performed at 190° C. for 10 hours in a vacuum atmosphere.

The measurement results are shown in Table 3.

TABLE 3

| | Heat treatment temperature | Liquid content |
|---|---|---|
| Reference Example 1 | No heat treatment | 15.8% |
| Reference Example 2 | 150° C. | 1.4% |
| Reference Example 3 | 190° C. | 0.7% |

As is evident from the results shown in Table 3, as the heat treatment temperature of polyacrylonitrile increases, the liquid content decreases. Consequently, it is believed that the liquid-absorbing property of the binder covering the negative electrode active material is also decreased by heat treatment. Therefore, it is believed that by heat-treating the binder in accordance with the present invention, the contact between the nonaqueous electrolyte solution and the negative electrode active material is limited, and side reactions between the nonaqueous electrolyte solution and the negative electrode active material is inhibited, resulting in improvement in cycle characteristics.

Furthermore, it is believed that removal of CN is caused by heat treatment of polyacrylonitrile or a modified form thereof. It is believed that the liquid content of the nonaqueous electrolyte solution is decreased by such removal of CN.

### REFERENCE SIGNS LIST

1 container
2 electrolyte solution
3 electrode body
4 reference electrode
5 negative electrode
6 nickel tab
7 tab
8 counter electrode
9 porous membrane made of polypropylene
10 glass plate

1.-5. (canceled)

6. A nonaqueous electrolyte secondary battery comprising a positive electrode containing a positive electrode active material, a negative electrode containing a negative electrode active material, and a nonaqueous electrolyte,
wherein the negative electrode contains the negative electrode active material and a negative electrode binder, the negative electrode active material is a mixture of a graphite material and silicon and/or a silicon compound that is contained in an amount less than that of the graphite material, and
the negative electrode binder is polyacrylonitrile or a modified form thereof which has been heat-treated.

7. The nonaqueous electrolyte secondary battery according to claim 6, wherein the content of the negative electrode binder in the negative electrode is in a range of 2.0 to 10.0 parts by mass relative to 100 parts by mass of the negative electrode active material.

8. The nonaqueous electrolyte secondary battery according to claim 6, wherein the content of the silicon and the silicon compound in the negative electrode is less than 20% by mass relative to the total negative electrode active material.

9. The nonaqueous electrolyte secondary battery according to claim 7, wherein the content of the silicon and the silicon compound in the negative electrode is less than 20% by mass relative to the total negative electrode active material.

10. The nonaqueous electrolyte secondary battery according to claim 6, wherein the polyacrylonitrile or the modified form thereof has been heat-treated in an inert atmosphere at a temperature in a range of 130° C. to 200° C.

11. The nonaqueous electrolyte secondary battery according to claim 6, wherein the polyacrylonitrile or the modified form thereof has been heat-treated in an inert atmosphere at a temperature in a range of 150° C. to 190° C.
